(19) United States
(12) Patent Application Publication
(10) Pub. No.: US 2015/0047597 A1
(43) Pub. Date: Feb. 19, 2015

(54) METHOD AND MACHINE TOOL FOR MACHINING A ROTATIONALLY ASYMMETRICAL REGION

(71) Applicant: Volker Gniesmer, Alfed (DE)

(72) Inventor: Volker Gniesmer, Alfed (DE)

(73) Assignee: KS KOLBENSCHMIDT GMBH, Neckarsulm (DE)

(21) Appl. No.: 14/353,943

(22) PCT Filed: Sep. 11, 2012
(86) PCT No.: PCT/EP2012/067709

§ 371 Date: Sep. 3, 2014

(30) Foreign Application Priority Data
Oct. 28, 2011 (DE) 102011085442.8

(51) Int. Cl. B23P 15/10; F02F 3/16; F02F 3/26; B23B 5/36

(52) U.S. Cl. CPC B23P 15/10; B23B 5/36; F02F 3/16; F02F 3/26; B23B 2215/245
USPC 123/193.6; 82/1.11; 82/117

(57) ABSTRACT

In order to machine at least one workpiece on a lathe, where the workpiece rotates in the lathe and the at least one region to be machined of the workpiece is machined with the aid of at least one tool of the lathe, where the tool is moved at least parallel to the rotation axis of the workpiece, where the tool is moved parallel to the rotation axis of the workpiece such that the machined region of the workpiece is formed in a rotationally asymmetrical manner with respect to the rotation axis of the workpiece after machining. Furthermore, the invention disclosure relates to a cooling duct to a piston wall, and to a combustion-chamber hollow of a piston and also to a lathe.

### BACKGROUND

The disclosure relates to a method for machining at least one work piece on a lathe, wherein the work piece rotates in the lathe and at least one region of the work piece to be machined is machined using at least one tool on the lathe, wherein the tool is moved at least parallel to the rotational axis of the work piece. The disclosure further relates to a lathe for machining at least one rotating work piece using at least one tool. The disclosure further relates to a cooling channel of a piston for an internal combustion engine to cool the piston using coolant, a piston wall of a piston for an internal combustion engine and a combustion bowl of a piston for an internal combustion engine.

A piston for a combustion engine and a method for producing a piston are known from DE 10 2005 060 547 A1. Using a first procedural step, a combustion bowl is turned into the piston crown using a lathe with a circumferential undercut and a circumferential bowl edge. In a second procedural step to produce the rounded and sharp-edged bowl edge regions, the lathe is displaced radially outwards in a straight line by a specified amount starting from the center point of the combustion bowl. The piston produced using this procedure has a rotationally symmetrical combustion bowl, the center point of which lies on the longitudinal axis of the piston.

The disadvantage of such a known method for producing a piston is that only rotationally symmetrical regions can be produced on the work piece. Only by using an additional subsequent procedural step is it possible to create a rotationally asymmetrical region on the work piece. Known methods to produce a rotationally asymmetrical region on the work piece are milling, for example, three-dimensional milling (3-D milling). It is further known as an alternative for a rotationally asymmetrical region on a work piece to be produced directly using a primary forming method, for example, casting, as part of the production of the work piece blank. Milling as a subsequent procedure is complex and cost-intensive. Primary forming is complicated compared with turning.

It is, therefore, desirable to enable simple, cost-effective and rapid machining of a work piece wherein a region of the work piece is to be formed rotationally asymmetrically.

### SUMMARY

This is achieved in the disclosure by moving the tool parallel to the axis of rotation of the work piece in such a way that the machined region of the work piece is formed rotationally asymmetrically with reference to the axis of rotation of the work piece when machining is finished.

Using a single tool, a work piece can be machined both rotationally asymmetrically and rotationally symmetrically. Because the infeed of the tool is parallel to the axis of rotation of the work piece, the machining of approximately flat work piece surfaces is also possible. Any (rotationally) asymmetrical shapes for the work piece with reference to the axis of rotation of the work piece can be generated as part of the production of the work piece. The method is furthermore cost-effective, can be performed quickly, and is easily realizable on a lathe.

The tool is also moved perpendicular to the axis of rotation of the work piece. The axis of rotation is the axis about which the work piece chucked in the lathe rotates.

The motion of the tool depends on the position of the tool with respect to the position of the work piece in the lathe and/or on the speed of the work piece during the machining, that is to say, during the turning operation. By adjusting the position of the tool to the position of the work piece and/or to the speed of the work piece, it is consequently possible to machine the work piece rotationally asymmetrically and/or rotationally symmetrically in regions. For example, it is possible to generate rotational asymmetry by moving the tool in the direction of the work piece maintaining a constant distance of the tool to the axis of rotation of the work piece so that the tool, with respect to the circumference making one rotation, is fed variously towards the work piece so that as a result rotational asymmetry is formed on the surface of the work piece.

A work piece surface, such as an approximately planar work piece surface, is machined into a domed work piece surface using the tool. The curvature of the work piece surface can be finished in the shape of a drop, a sphere, an egg, a dome or similar.

It can be seen, therefore, that normal and thus known turning operations from the prior art have a motion of the tool in the radial direction of the work piece, that is to say, perpendicular to the axis of rotation of the work piece, and in a direction parallel to the axis of rotation of the work piece. The present tool, in addition to these potential motions previously described, is additionally deflected in a controlled manner during a rotation of the work piece in a direction parallel to the axis of rotation so that differences in height are created over a peripheral length of the work piece. Consequently, a controlled motion of the tool in the direction of the vertical axis of the work piece is superposed on the normal rotational movement, which ensures that correctly positioned differences in height are realized during a revolution of the work piece.

Using the present method it is possible to incorporate the cooling channel into the position rotationally asymmetrically with respect to the axis of rotation of the piston. As a result, it is possible that during operation a cooling channel of this sort in an internal combustion engine, a preferred and optimal cooling of the piston is possible as a result of the rotationally asymmetrical shape. Furthermore, the strength of the cooling channel and thus of the piston is improved.

The piston may consist of steel, aluminum or an aluminum alloy, for example. The piston may further be a one-piece or multi-piece design.

It is further possible using the method to produce a cooling channel with a contour, for example, a ContureKS cooling channel from KS Kolbenschmidt GmbH in Neckarsulm, Germany. In the case of a contoured cooling channel, the cross-section of the cooling channel varies with respect to the circumference of the piston. This variable cross-section in the cooling channel with contour is formed by sliding transitions between two cross-sections of different heights being formed in the running and piston pin direction of the piston, which permits optimal adaptation to the stress situation in the piston. In addition, the shaker effect of the coolant, for example, engine oil, and thus the heat transfer during the reciprocating motion of the piston in the cylinder of the internal combustion engine, is improved by greater heights of the cross-sectional profile, whereby a clear temperature reduction of the piston operating in an internal combustion engine is achieved using the shape of the contoured cooling channel.

Using the method it is possible to machine the piston wall rotationally asymmetrically with respect to the axis of rotation of the piston. As a result, it is possible that piston weight is reduced, piston wall stiffness is optimized, piston stability is improved, and temperature characteristics are optimized during piston operation in an internal combustion engine.

Using the method, it is possible to incorporate the combustion bowl rotationally asymmetrically with respect to the axis of rotation of the piston. As a result, it is possible that the air-fuel mixture sprayed towards the combustion bowl when the piston is operating in an internal combustion engine is advantageously mixed regardless of the position and movement of the piston in the internal combustion engine. Thus, there is optimal fuel combustion during a complete cycle of piston motion in the internal combustion engine.

The lathe can be operated using the method.

### BRIEF DESCRIPTION OF DRAWINGS

Aspects in accordance with the method, tool and piston are shown in the FIGS. in which:

FIG. 1 shows a work piece in cross-section in part of a lathe shown in a side view;

FIG. 2 shows the work piece in the lathe in a plan view.

FIG. 3 shows a piston undergoing metal-removal machining in cross-section in a side view perpendicular to the piston pin bore;

FIG. 4 shows the piston in cross-section looking towards the piston pin bore; and

FIG. 5 shows a developed view of the cooling channel.

### DETAILED DESCRIPTION

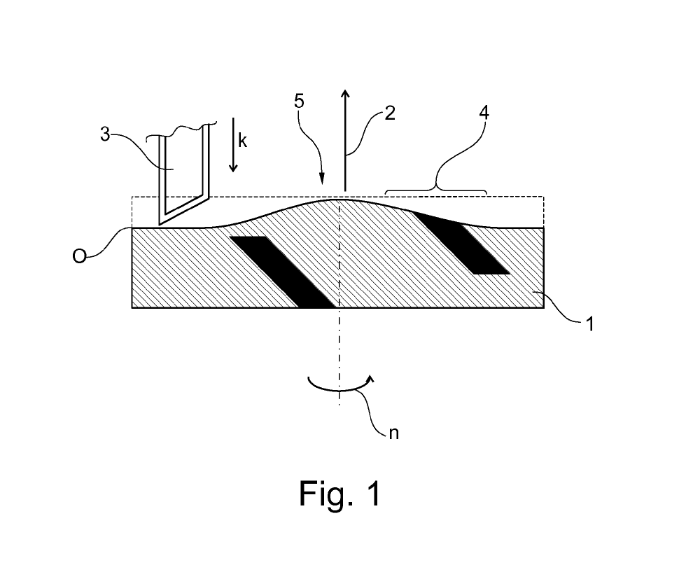

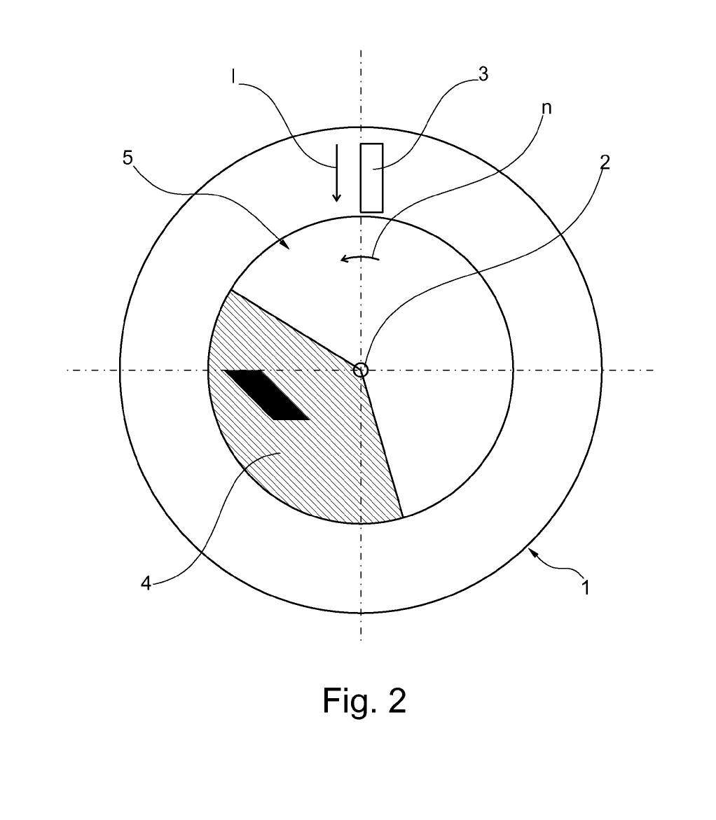

FIG. 1 shows a side view of a work piece 1 in a section of a lathe. The already machined work piece is shown in the cross-section in FIG. 1. The region of the work piece indicated by the broken line shows the unmachined work piece 1, that is so say, no material has been removed, in the lathe before it is machined in the lathe. FIG. 2 shows the work piece in the lathe in plan view.

In what follows, the method for machining the work piece 1 from FIG. 1 and FIG. 2 is described in detail.

To machine the work piece 1 shown by the broken line in FIG. 1, the work piece 1 rotates at a speed n around an axis of rotation 2 in the lathe.

In this aspect, in order to machine the unfinished work piece 1 rotating at the speed n, a tool 3 is moved parallel to the axis of rotation 2 of the work piece 1 in the direction of motion k of the tool 3 during one rotation of the work piece 1. In addition, the tool 3 is moved in accordance with FIG. 2 perpendicular to the axis of rotation of the work piece 1 when machining in direction I during one rotation of the work piece 1. The tool 3 is moved parallel to the axis of rotation 2 during one revolution of the work piece 1 during the machining of the work piece 1.

The tool 3 in this aspect is configured as a turning tool for a lathe.

After the tool 3 touches the work piece 1 by infeed in the region of the work piece 1 to be machined, the work piece is machined using the tool 3 in the lathe. The motion of the tool 3 depends on the position of the tool 3 with respect to the position of the work piece 1 in the lathe and on the speed n of the work piece 1 during machining. With increasing distance from the axis of rotation 2, the peripheral speed of the work piece 1 in the lathe increases. As an alternative or a supplement, the peripheral speed of the work piece 1 in the lathe can be increased or reduced at a specific point of the work piece 1 using the speed n. The motion of the tool 3, which is always adjusted accordingly, is realized in this aspect using the controls on the lathe.

Using this adjusted motion of the tool 3 in directions k and I, FIGS. 1 and 2 it is possible that the machined region of the work piece 1 is formed rotationally asymmetrically with respect to the axis of rotation 2 of the work piece 1 during and after the machining of the work piece 1.

As the tool 3 was moved in direction k of the tool parallel to the axis of rotation 2 of the work piece 1 and in direction I perpendicular to the axis of rotation of the work piece 1, the work piece 1 has a rotationally asymmetrical region 4 in accordance with FIG. 1 and FIG. 2 following machining of the work piece 1.

The rotationally asymmetrical region 4 is shown as a cross-hatched surface compared with the rotationally symmetrical region from FIG. 2. Thus, using the tool 3, a turned contour was produced on the work piece 1 that has a height difference in the peripheral direction of the work piece 1 with a constant interval to the axis of rotation 2.

Using the method for machining the work piece 1 on a lathe, the approximately planar unmachined surface of the work piece 1 shown by the broken line, that is to say, a region of the work piece 1 to be machined, was machined into a domed work piece surface 5 using the tool 3 on the lathe in accordance with FIG. 1 and FIG. 2, which also has a rotationally asymmetrical region 4 in accordance with FIG. 1 and 2.

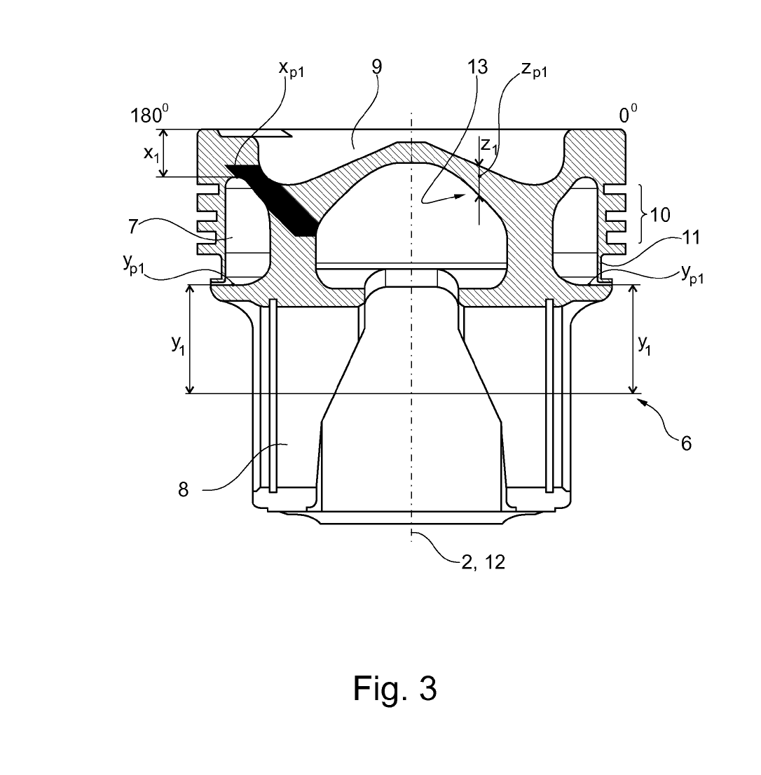

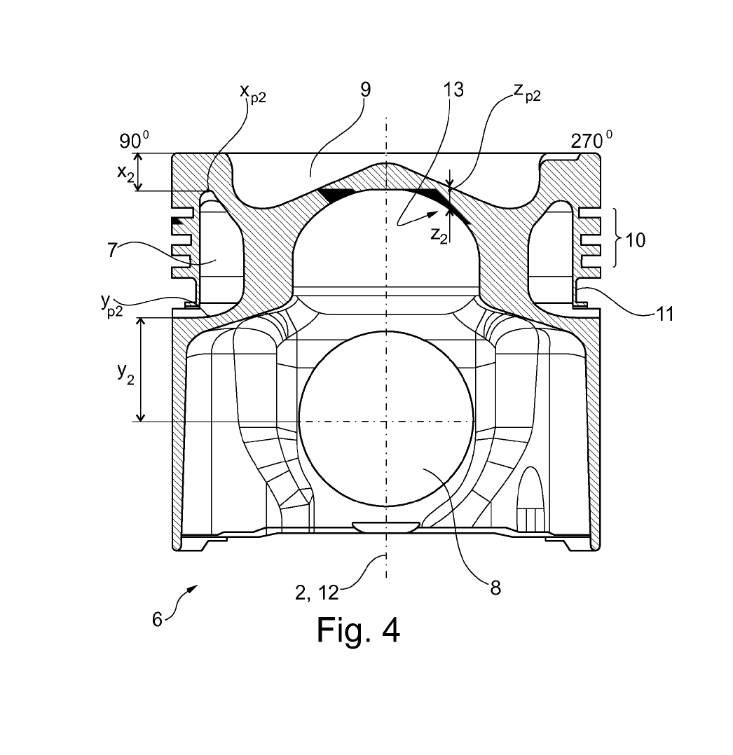

FIGS. 3 and 4 show a completed piston 6 for an internal combustion engine, consisting of steel in this aspect. In accordance with FIGS. 3 and 4, the piston 6 has a cooling channel 7, a piston pin bore 8 passing through the piston 6, a combustion bowl 9, and a ring zone 10. The ring zone 10 is completely peripheral in the radial direction around the stroke axis of the piston 6, that is to say, around the entire circumference of the piston 6. The stroke axis 12 of the piston 6 is the axis that the piston 6 passes through when operating in an internal combustion engine. The stroke axis 12 in the aspect from FIG. 3 and FIG. 4 forms one of the center axes of the piston 6. Furthermore, the cooling channel 7 in the piston 6 is completely circumferential in the radial direction around the stroke axis 12 of the piston 6. The single-piece piston 6 in this aspect has a cooling channel plate 11 in the region below the ring zone 10 that closes off the cooling channel 7.

During operation of the piston 6 in the internal combustion engine, the cooling channel 7 is cooled using coolant, for example, engine oil, and thus the piston 6 is also cooled.

In order to produce a piston 6 of this type, the piston 6 is chucked as a blank into a lathe not shown in FIGS. 3 and 4 and machined using a tool also not shown in FIGS. 3 and 4, for example, a lathe tool or several different lathe tools for a lathe, wherein the piston 6 rotates in the lathe and the region of the piston 6 to be machined is machined using the tool in the lathe. The tool is moved at least parallel to the axis of rotation 2 of the piston 6 during the machining of the rough work piece in the form of the piston blank in this aspect. In the aspect from FIGS. 3 and 4, the axis of rotation 2 of the piston 6, that is, of the work piece, is identical to the stroke axis 12 of the piston 6.

The tool used in the lathe for machining the piston 6 is moved perpendicular and/or parallel to the axis of rotation of the piston 6 in such a way that the machined region of the piston 6 is formed rotationally asymmetrically with respect to the axis of rotation of the piston 6 after the machining on the lathe. As an alternative, it is possible that machined regions of the piston 6 are machined rotationally symmetrically using the tool.

The regions of the piston blank to be machined on the lathe can have a shape already prematched to one of the later machined shapes. It is possible, for example, that the combustion bowl 9 is predefined as an unmachined bowl in the piston blank, that is, the work piece. As an alternative, for example, it is also possible that the combustion bowl 9 is predefined rotationally symmetrically and finish machined in the piston blank and the bowl is only completely finished rotationally asymmetrically on the lathe by machining.

It is alternatively possible that the regions of the piston blank to be machined on the lathe do not have a prematched shape.

In the aspect from FIGS. 3 and 4, the combustion bowl 9 in the piston blank is finish machined rotationally symmetrically before machining on the lathe in accordance with the method.

In accordance with FIGS. 3 and 4, the piston 6 finish machined on the lathe shows an asymmetry in two regions in the cooling channel with respect to the radial orbit around the stroke axis 12. The cooling channel 7 is consequently incorporated rotationally asymmetrically into the piston 6 in these regions with respect to the axis of rotation 2 of the piston 6. The asymmetry is recognizable in FIGS. 3 and 4 in a comparison of positions xₚ₁, xₚ₂ and yₚ₁, yₚ₂. Position xₚ₁ is at a distance x₁ from the edge of the top side of piston 6 in accordance with FIG. 3. Position xₚ₂ is at a distance x₂ from the edge of the top side of piston 6 in accordance with FIG. 4. Position yₚ₁ is at a distance of y₁ in accordance with FIG. 3, and position yₚ₂ is at a distance y₂ from the center axis of the piston pin bore 8 in accordance with FIG. 4. The piston 6 thus shows an asymmetry in the region of its inside.

It is furthermore possible that the piston 6 shows an asymmetry in a region of a piston wall 13 shown in FIG. 3 and FIG. 4. A piston wall 13 machined rotationally asymmetrically with respect to the axis of rotation of piston 6 is shown on the inside of the piston 6 in the aspect in accordance with FIGS. 3 and 4 .

Using the tool in the lathe in the region of the piston wall shown in FIGS. 3 and 4, the piston wall 13 has been machined rotationally asymmetrically with respect to the axis of rotation of the piston 6 by removing one region of the piston wall 13 of the piston blank in accordance with FIG. 4 using the tool in position zₚ₂ to remove metal. With the aid of this removal process, the wall thickness z₂ in the position zₚ₂ of the piston 6 below the combustion bowl 9 has been reduced in accordance with FIG. 4. In FIG. 3 the region not removed in position zₚ₁ is shown with the wall thickness z₁. The asymmetry created below the combustion bowl 9 in the inner region of the piston 6 can be seen in a comparison of the positions zₚ₁, zₚ₂ in FIGS. 3 and 4.

It is further possible for the rotationally symmetrical combustion bowl predefined on the piston blank in this aspect to be machined into a rotationally asymmetrically formed combustion bowl 9 with respect to the axis of rotation of the piston 6. To do this, as the piston blank is rotating, the lathe tool is moved parallel to the axis of rotation of the piston blank towards the surface of the predefined combustion bowl 9 in such a way during a revolution of the piston blank that a rotationally asymmetrical combustion bowl is formed after machining. For the machining of the rotationally symmetrical combustion bowl 9, the piston blank must be rechucked in the lathe. A rotationally asymmetrical combustion bowl of this kind is not shown in FIGS. 3 and 4.

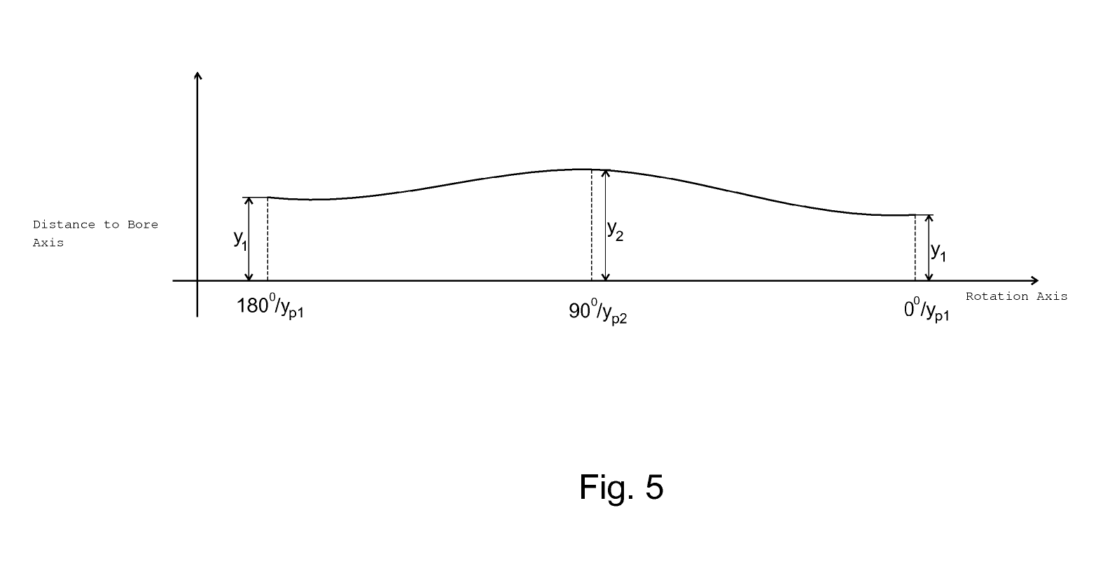

FIG. 5 shows, as an example, an area of the rotationally asymmetrical region of the piston 6 in a developed view. In accordance with FIG. 5, the region between 0° and 180° in the radial peripheral direction, that is to say over one half side of the piston 6, has been processed with a constant distance to the stroke axis 12 of the piston 6. The piston 6 is thus processed in the circumferential direction maintaining a constant distance to the stroke axis 12 of the piston 6.

It becomes clear from the developed view in accordance with FIG. 5 that the cooling channel follows an asymmetrical course between the positions yₚ₁, and yₚ₂ and further to position yₚ₁ in the piston 6 in the developed view. The distance y₁ of position yₚ₁ in accordance with FIG. 3 and the distance y₂ of position yₚ₂ in accordance with FIG. 4 is measured in each case with respect to the center axis of the piston pin bore 8.

Positions xₚ₁, xₚ₂, yₚ₁ and yₚ₂ and zₚ₁, zₚ₂ in accordance with the aspect from FIGS. 3 and 4 are not restricted to the positions shown as an example in the piston 6.

For example, it is possible as an alternative that the positions xₚ₁, yₚ₁ are located at the 90° position and positions xₚ₂ and yₚ₂ are located at the 180° position in accordance with FIG. 3 with appropriately machined regions of the piston 6 (not shown in FIGS. 3 and 4).

It is possible as a further alternative that the machined regions at positions xₚ₁, xₚ₂, yₚ₁ and yₚ₂ and zₚ₁, zₚ₂ have been machined in such a manner that any rotationally asymmetrical progression diverging from FIG. 3 and FIG. 4 between the points xₚ₁, xₚ₂, yₚ₁ and yₚ₂ and zₚ₁, zₚ₂ corresponding to each other is possible (not shown in FIG. 3 and FIG. 4).

What is claimed is:

1. A method for machining at least one work piece on a lathe, wherein the work piece rotates in the lathe and the at least one region of the work piece to be machined is machined using at least one tool of the lathe, wherein the tool is moved at least parallel to the axis of rotation of the work piece, comprising:
moving the tool parallel to the axis rotation of the work piece in such a manner that the machined region of the work piece is formed rotationally asymmetrically with respect to the axis of rotation of the work piece.

2. The method from claim 1, wherein further comprising:
moving the tool perpendicular to the axis of rotation of the work piece.

3. The method from claim 1, wherein the motion of the tool depends on the position of the tool with respect to the position of the work piece in the lathe and/or on the rotational speed (n) of the work piece during the machining.

4. The method from claim 1 further comprising machining a work piece surface; into a domed work piece surface the tool.

5. A cooling channel of a piston for an internal combustion engine for cooling the piston using coolant, wherein the cooling channel is incorporated into the piston rotationally asymmetrically with respect to the axis of rotation of the piston.

6. A piston wall of a piston for an internal combustion engine, wherein, using the method from claim 1, the piston wall is machined rotationally asymmetrically with respect to the axis of rotation of the piston.

7. A combustion bowl of a piston for an internal combustion engine, wherein the combustion bowl machined into the piston rotationally asymmetrically with respect to the axis of rotation of the piston using the method from claim 1.

8. A lathe for machining at least one rotating work piece using at least one tool, wherein the lathe can be operated using the method from claim 1.
